(19) United States
(12) Patent Application Publication
(10) Pub. No.: US 2026/0099433 A1
(43) Pub. Date: Apr. 9, 2026

(54) DECISION ENGINE FOR SOFTWARE INTEGRITY AND RELEASABILITY

(71) Applicant: Raytheon Company, Arlington, VA (US)

(72) Inventors: Jose Romero-Mariona, San Diego, CA (US); James Poirier, San Diego, CA (US); Daniel A. Hollberg, Burke, VA (US); Kwok Liang Poo, Lake Forest, CA (US); Jason Kong, Irvine, CA (US); Michael Dierickx, Temecula, CA (US)

(21) Appl. No.: 19/352,068

(22) Filed: Oct. 7, 2025

Related U.S. Application Data
(60) Provisional application No. 63/704,295, filed on Oct. 7, 2024.

(51) Int. Cl. G06F 11/3668

(52) U.S. Cl. CPC G06F 11/3688

(57) ABSTRACT

Discussed herein are devices, systems, machine-readable media, and methods for assessing a software build for a vulnerability, generating release recommendations, and implementing a remedial action to mitigate security risks. A method includes receiving a Software Bill of Materials (SBOM) that lists one or more libraries used in a software build, receiving a user-specified administration policy, generating an over overall provenance bundle from a metadata of the one or more libraries used in the software build, implementing a gradient boosted tree algorithm using both the overall provenance bundle and the user-specified administration policy to generate a software releasability recommendation, receiving the software releasability recommendation into a Large Language Model (LLM) to generate a recommendation report detailing one or more software vulnerabilities, and implementing the software releasability recommendation by releasing the software build or blocking the release of the software build based on the software releasability recommendation.

### PRIORITY CLAIM

This application claims benefit of priority to U.S. Provisional Application No. 63/704,295, filed Oct. 7, 2024, and titled “Design Engine for Software Integrity and Releasability”, which is incorporated herein by reference in its entirety.

### TECHNICAL FIELD

Embodiments discussed herein regard devices, systems, machine-readable media, and methods in the field of software security and quality assurance, specifically for assessing a software build for a vulnerability, generating release recommendations, and implementing a remedial action to mitigate security risks.

### BACKGROUND

Current software builds are constructed based on code from open-source libraries. As a result, these compiled software builds of open-source libraries are susceptible to vulnerabilities that can be exploited by malicious actors. These vulnerabilities can be inherent in the code from the open-source libraries, or deliberate vulnerabilities built into the libraries from malicious of nefarious actors. To provide visibility into potential vulnerabilities in open-source libraries, third parties compile and maintain lists of Common Vulnerabilities and Exposures (CVEs) for various open-source libraries. These lists typically include a Common Vulnerability Scoring System (CVSS) score. CVSS is a standardized method for assessing and quantifying the severity of software vulnerabilities. The CVSS score is widely used in the cybersecurity industry and is particularly relevant in the context of software builds comprising code from open-source libraries.

### BRIEF DESCRIPTION OF THE DRAWINGS

FIG. 1 illustrates, by way of example, a diagram of an embodiment of a system including a decision engine for software integrity and releasability (DESIR).

FIG. 2 illustrates, by way of example, a diagram of an embodiment of a system that includes SBOM input into a decision engine of FIG. 1.

FIG. 3, illustrates, by way of example, a diagram of a gradient boosted decision tree.

FIGS. 4A and 4B illustrate, by way of example, respective diagrams of embodiments of DESIR releasability reports.

FIG. 5 illustrates, by way of example, a flow diagram of an embodiment of an iterative process for assessing a vulnerability in a software build.

FIG. 6. Illustrates, by way of example, a diagram of an embodiment of a method for assessing a software vulnerability in a software build and mitigating the software vulnerability through a remedial action.

FIG. 7 illustrates, by way of example, a machine learning (ML) engine for training a ML model.

FIG. 8 illustrates, by way of example, a block diagram of an embodiment of a machine in the example form of a computer system within which instructions, for causing the machine to perform any one or more of the methodologies discussed herein, may be executed.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

In a rapidly evolving landscape of digital technology, cybersecurity has traditionally been characterized by a reactive approach rather than a proactive one. This reactive approach has long been the standard operation for many organizations, where security measures are often implemented as responses to identified threats or actual breaches. Such an approach, while common, leaves systems vulnerable to emerging threats and zero-day exploits. The reactive model typically involves waiting for a security incident to occur, analyzing the breach, and then developing countermeasures to prevent similar future attacks. The reactive approach, however, inherently exposes organizations to significant risks and potential damages before protective measures can be put in place. As cyber threats become increasingly sophisticated and frequent, the limitations of this reactive approach have become apparent, highlighting the critical need for a shift towards more proactive and predictive cybersecurity strategies.

A security vulnerability of this reactive model is further exacerbated by how software builds are assembled from a variety of different libraries that are open-sourced. The use of these open-source libraries to develop software builds are particularly attractive due to the increasing complexity of software builds with different and multiple functionalities. The use of open-source libraries allows developers to incorporate these desired functionalities quickly and easily, without the need to write code from scratch. Other benefits of leveraging open-source libraries in software builds include cost-effectiveness, availability of community support, and the enablement of rapid software development leading to faster go-to-market cycles.

In this context, a software build refers to the compiled and executable version of a software project, which can be synonymous with “software project”, “software code, or “software package”. Software builds can represent the collective set of source code files, dependencies, and resources that comprise a software application or system.

However, the use of open-source libraries can potentially expose the software build to a vulnerability that can be exploited by malicious or nefarious actors. Open-source libraries are collections of pre-written code, functions, and modules that are freely available for use, modification, and distribution by developers. These open-source libraries are typically developed collaboratively by a community of programmers and can be released under licenses. Alternatively, some open-source libraries can also be used in an unrestricted manner for either commercial or non-commercial projects. Due to the open nature of these open-source libraries, there is often limited formal oversight or regulation regarding the quality or security of the code. The lack of oversight can lead to either unintended security vulnerabilities or deliberate inclusion of malware and backdoors into these open-source libraries. As a result, the inclusion of a vulnerable open-source libraries into a software build can result in the vulnerability being present in the developed software build. The vulnerability can be exploited by malicious or nefarious third parties. Consequently, there is increasing demand to verify software supply chain integrity and obtain assurance that a given software build is free from vulnerability that can be susceptible to exploitation. Note that a given entity can be comfortable with a software build including a vulnerability. The DESIR helps such an entity understand a vulnerability in a software build. The entity can then assess whether to remove the vulnerability or release the software build.

To mitigate these software vulnerabilities, Common Vulnerabilities and Exposures (CVEs) are compiled. CVEs are known vulnerabilities for individual open-source libraries. CVEs include standardized identifiers for publicly disclosed cybersecurity vulnerabilities. Some aspects of a CVE include: (1) a unique identifier, (2) standardization of a common language for describing and categorizing a vulnerability, (3) a vulnerability description, (4) public disclosure to allow public access in an effort to promote transparency and risk assessment, (5) various vulnerability assessment and risk prediction metrics, and (6) patch management to help developers and organizations prioritize and apply updates. These CVEs are compiled as lists that serve as tools in the areas of cybersecurity and vulnerability management. An example of a CVE list is the one maintained by the MITRE Corporation of McLean, Virginia, United States of America, a non-profit organization, in partnership with the United States Department of Homeland Security.

These CVEs can also be related to various vulnerability assessment and risk prediction metrics. Examples of these risk prediction metrics include the Common Vulnerability Scoring System (CVSS), Exploit Prediction Scoring System (EPSS), Damage, Reproducibility, Exploitability, Affected users, Discoverability (DREAD), and Vulnerability Priority Rating (VPR).

The CVSS score associated with a CVE is a system of standardized scores with a numerical rating used to assess and quantify the severity of a software vulnerability. The score ranges from 0.0 to 10.0, with higher scores indicating more severe vulnerabilities. CVSS can be categorized into various severity levels such as low (e.g., 0.0 to 3.9), medium (e.g., 4.0 to 6.9), high (e.g., 7.0 to 8.9), and critical (e.g., 9.0 to 10). The scores can be calculated based on a variety of factors such as (1) attack complexity, (2) required privileges, (3) user interaction, (4) scope, (5) confidentiality impact, (6) integrity impact, and (7) availability impact.

A CVE can also have associated Exploit Prediction Scoring System (EPSS) score. The EPSS is a data-driven, open scoring system that estimates the probability of a vulnerability being exploited within the next 30 days. This 30-day prediction window provides organizations with a short-term forecast to help prioritize vulnerability management efforts. For example, if a CVE has an EPSS score of 0.75, the EPSS score indicates that there is a 75% probability that this vulnerability will be exploited within the next 30 days.

However, over time, these vulnerability assessment and risk prediction metrics can gradually get inflated, referring to the increasing tendency for a vulnerability to receive a higher severity rating over time. One such example is the inflation of CVSS scores. This can result in an open-source library with a high CVSS score that does not actually have a credible vulnerability that can be easily exploited. Potential causes of CVSS score inflation can include (1) an evolving threat landscape, (2) increasing connectivity of systems, (3) heightened security awareness, (4) pressure from stakeholders leading vendors and researchers to report higher scores to highlight vulnerabilities, and (5) inherent limitations of the scoring system to keep up with ever evolving vulnerabilities. This trend of inflation of CVSS scores can lead to inaccurate diagnosis of vulnerabilities through user desensitization, resource misallocation, a false sense of urgency and/or a growing mistrust of the CVSS system. This increase in inaccurate diagnosis can lead to significant downstream impact to software development that include increased development costs, delayed release of products and reduced focus on actual high-risk issues.

To address these challenges and issues, embodiments provide systems, methods, devices, and machine-readable media to determine if a software build meets certain releasability criteria. Embodiments can further provide supporting evidence for a releasability determination. Embodiments receive a Software Build of Materials (SBOM) that identifies individual libraries of the software build. Embodiments can retrieve associated information such as CVE lists, CVSS scores and library historical metadata. Embodiments can provide, based on the retrieved associated information, a releasability assessment that can be in the form of a releasability score or releasability recommendation. In addition, embodiments can also provide a recommendation of a remedial action that can be performed to mitigate the vulnerability. A remedial action can include a patch or replacement of software code that is part of a library in the software build. Embodiments can include the automatic patching, updating, replacing, or a combination thereof of a vulnerable library.

Embodiments can employ a plug and play model that is platform agnostic. Embodiments can integrate into existing continuous software build integration pipelines. Embodiments can allow for full integration with continuous integration and continuous delivery workflows such as Jenkins and Github Actions. Continuous integration and continuous delivery are software development practices that automate the process of building, testing, and deploying code changes in a streamlined and efficient manner.

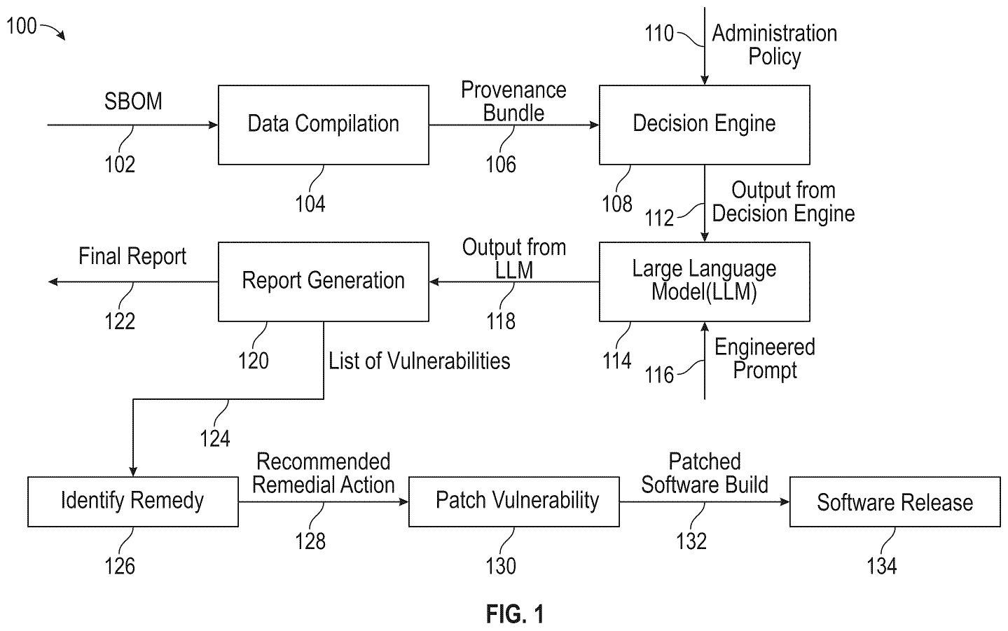

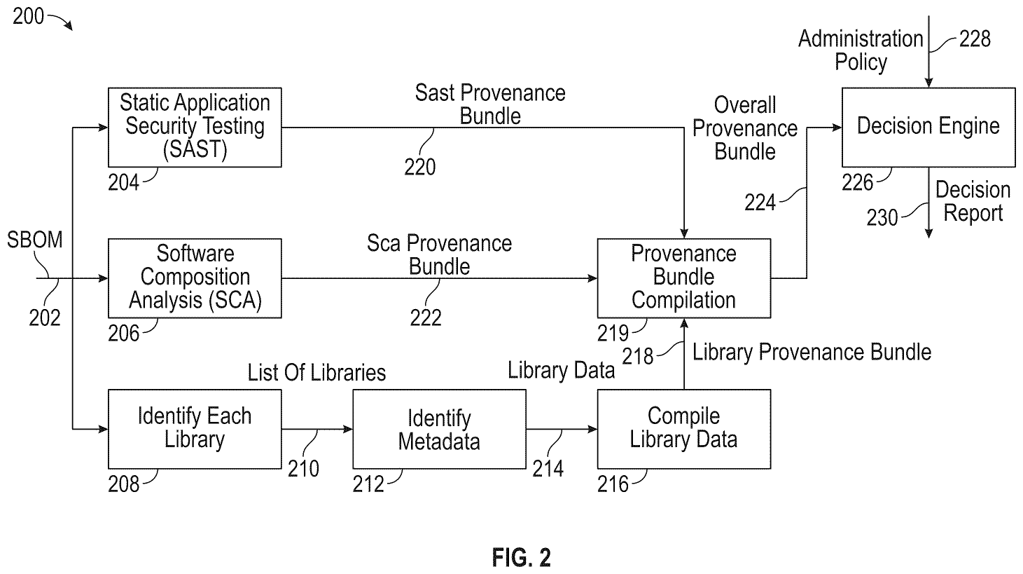

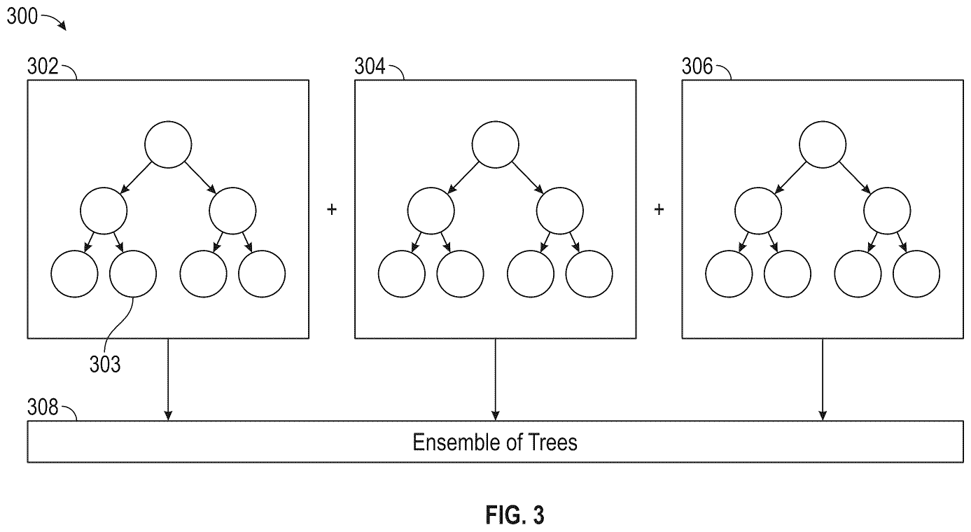

FIG. 1 illustrates, by way of example, a diagram of an embodiment of a system including a decision engine for software integrity and releasability (DESIR). As used herein, the term “decision engine for software integrity and releasability” may be used interchangeably with “DESIR” and “decision engine”. The system, as illustrated, receives a software build's software bill of materials (SBOM) 102 into a data compilation operation 104. The data compilation operation 104 can isolate the SBOM 102 into its constituent libraries and retrieve associated metadata of each library identified in the SBOM 102. The data compilation operation 104 then compiles the gathered data and outputs a provenance bundle 106 that can include metadata of the library corresponding to either its security-related attributes, its author-related attributes, or a combination thereof. The additional metadata gathered in the data compilation operation 104 assist in making a data driven assessment of the software build being assessed. Details of the data compilation operation 104 are provided further in the discussion of FIG. 2. The provenance bundle 106 can be loaded into the decision engine 108 alongside with an administration policy 110. The administration policy 110 is a user-defined risk profile that can dictate the evaluation of the releasability of the software build based on one or more risk parameters. The input of the administration policy 110 into the decision engine 108 can allow the user flexibility in determining different risk levels for different types or software builds. The added flexibility can also be applied to the same software build at different milestones of a development process. For example, a nascent software build in the early stages of development may tolerate higher levels of risk compared to a software build that is close to launch, allowing for changing risk profiles. Details of administration policy 110 and its risk parameters are provided further in the discussion of FIG. 2. Once both the provenance bundle 106 and administration policy 110 is input into the decision engine 108, the decision engine 108 can use a statistical model to generate a releasability report that can include a releasability score. The statistical model used in the decision engine 108 can be a gradient boosted decision tree, and more details about the gradient boosted decision tree is provided in the discussion of FIG. 3. The output from the decision engine 112 can include a releasability report, a releasability score, and the provenance bundle 106. The releasability report can include, for example, the metrics used in the decision-making process executed by the decision engine 108. The releasability score can indicate the probability that the software build is vulnerable to exploitation. The releasability score can also provide an aggregated risk level that is easily understood by a user quickly, without the need to look at a detailed analysis. The provenance bundle 106 can be included in the output from the decision engine 112 to provide metadata and supporting information to the LLM operation 114 and the report generation operation 120. Details of the output from the decision engine 112 is provided in the discussion of FIG. 2.

The output from the decision engine 112 can then be input into a LLM operation 114 via an engineered prompt 116. LLM operation 114 can assist in translating a large amount of information and data from the output from the decision engine 112 and the provenance bundle 106 into a format that can be easily understood by a user. The output from the LLM 118 can be optimized and adjusted based on the engineered prompt 116 provided to the LLM. The engineered prompt 116 can, for example, be manually composed by a user, automatically generated, or derived from predefined templates to determine each component of the output from the LLM 118.

The prompt 116 tells the LLM what it is and what its job is. An example prompt is provided: “You are a platform called DESIR which predicts the likelihood that a software project will have a vulnerability exploited within the next 30 days. Your mission is to summarize the data provided to you and determine how the underlying AI models you have determined the DESIR score. You can leverage all the data that is provided in the response, and it should be in paragraph form and roughly 3 paragraphs in length. The DESIR score determines the releasability of the project. If the DESIR score is too high and the releasability of the project is flagged to not be released, ensure that you explain why the decision to not release happened. Use the weights of the features from the gradient boosted decision tree model and identify the highest weighted features and draw correlations between them and the rest of the data provided.

In another 2 paragraphs, give suggestions and examples of how to mitigate the worst CVEs found in the project and show any patched versions or suggested alternatives to the libraries.

### Example Pseudocode of the Prompt:

Summarize the following data:
The DESIR score for this project is {DESIR_SCORE},
The releasability of the project is {RELEASABILITY},
The CVEs in the project are {CVE LIST},
The distribution of CVES in the project are {CVE DISTRIBUTION}—this is the number of Critical/High/Med/Low CVEs as % values
The weighting from the gradient boosted decision tree outputting the DESIR score is as follows {FEATURE WEIGHTS LIST sorted by most to least relevant},
Etc.

### Additional Context for Mitigation and Patching Notes:

The dependencies in the project are {DEPENDENCIES LIST},
The age of the project is {PROJECT AGE},
The average time between releases is {TIME TO RELEASE},
The number of contributors is {NUMBER CONTRIBUTORS}
Etc.

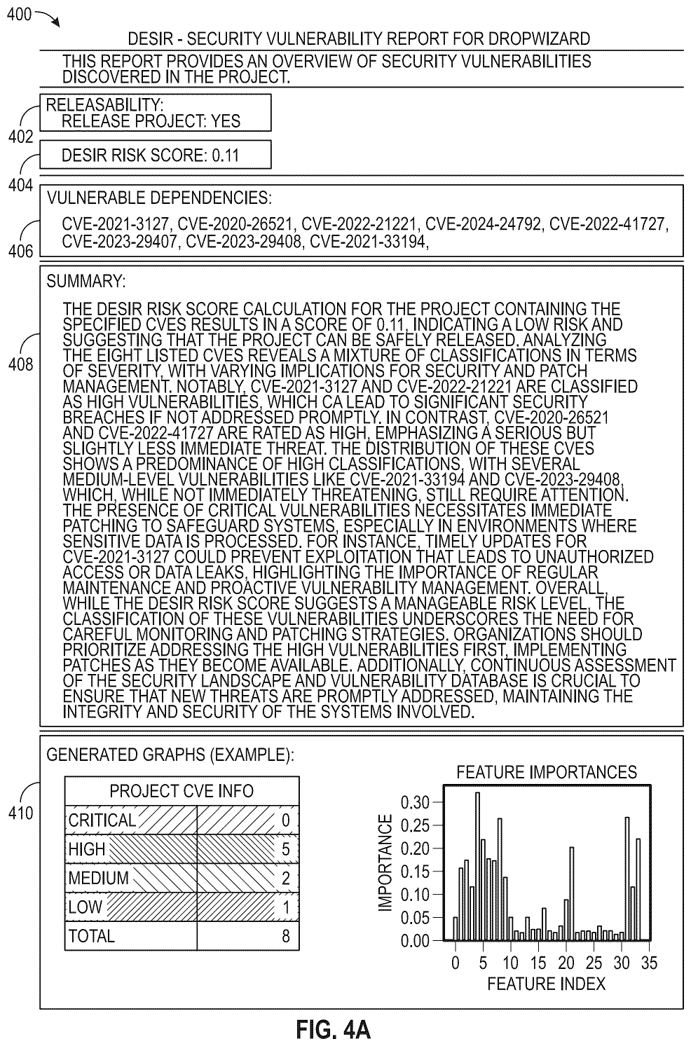

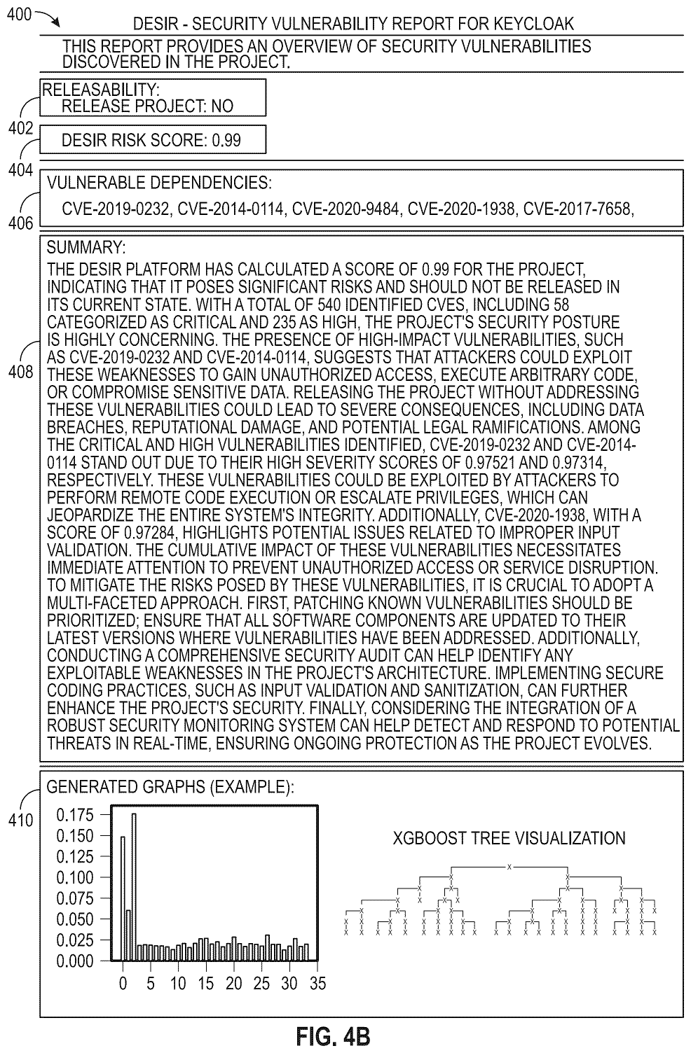

The output from the LLM 118 can then be input into the report generation operation 120 to output a final report 122 and a list of vulnerabilities 124. The final report 122 can include both textual or graphical format to enable the user to understand the output from the decision engine 112 and take action if needed. The report generation operation 120 can include integrating a graphical or image output from a program with the output from the LLM 118. The output of the report generation operation 120 is a final report 122, details of which is provide in the discussion of FIGS. 4A-B.

The output of the report generation operation 120 can also include a list of vulnerabilities 124 for input into a identify remedy operation 126. The identify remedy operation 126 can result in an identified vulnerable library having a corresponding recommended remedial action 128. This operation 126 can involve searching through available security updates, vendor-provided fixes, custom mitigation strategies, or a combination thereof to patch the specific vulnerability identified in the software build Examples of a recommended remedial action 128 can include identifying a recommended patch, updating of the affected library with a recommended patch, replacement of the vulnerable library, or a combination thereof.

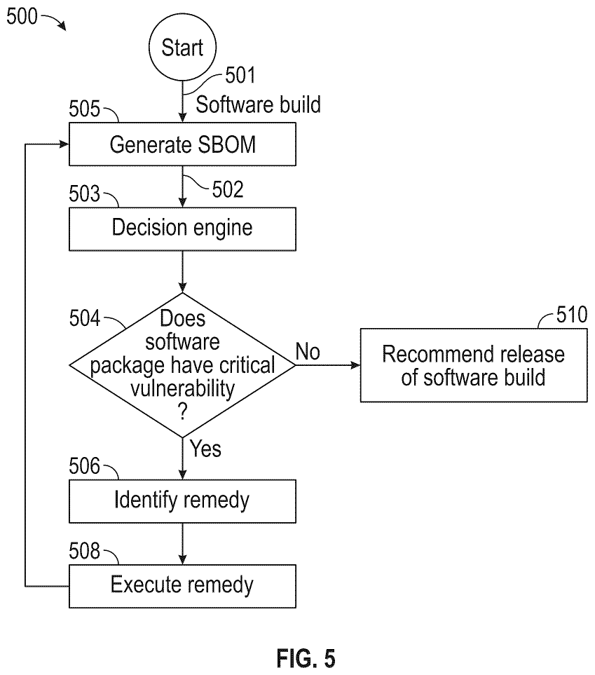

The recommended remedial action 128 can be acted upon at operation 130 to patch the identified vulnerability of the software build, resulting in a patched software build 132. The operation to patch the vulnerability 130 can either be manual or automated, with or without the intervention of a user or stakeholder. Details of the identify remedy operation and patch vulnerability operation are provided in the discussion of FIG. 5. Following the operation to patch vulnerability 130, the patched software build 132 can be routed for software release 134. Embodiments can allow for the patched software build to be rerouted through the system 100 again, to ensure that the software build no longer contain unacceptable software vulnerabilities. Details of this iterative process to reroute the software build through the system 100 again is provided in the discussion of FIG. 5. In certain embodiments, the software build can be released in the software release operation 134 even if a vulnerability has been identified.

Embodiments of the system 100 can have a plug and play functionality that is platform agnostic. Embodiments can include examples where the software build to be analyzed can include an executable code in the software build itself, or the software build to be analyzed can be dropped into the workflow of the system 100 separately.

FIG. 2 illustrates, by way of example, a diagram of an embodiment of a system that includes SBOM input into a decision engine of FIG. 1. The decision engine workflow 200 can receive a variety of different data inputs. In certain embodiments, the Software Bill of Materials (SBOM) 202 is an input. The SBOM is processed into a suitable input for the decision engine 226. The SBOM 202 is a formal, machine-readable inventory of software components and dependencies used in an application or system. A SBOM 202 can provide a comprehensive list of all the software components, libraries, and modules that make up a software build. A SBOM 202 can also include version information and licensing details of the open-source library.

Embodiments can employ a variety of different SBOM formats, for example, Software Package Data Exchange (SPDX), CycloneDX, Software Identification (SWID) tags, National Telecommunications and Information Administration (NTIA) SBOM format, or a combination thereof.

In certain embodiments, the SBOM 202 of the software build can then be subjected to traditional static application security testing (SAST) 204. SAST is a type of security testing that analyzes source code or compiled versions of code to identify potential security vulnerabilities. Examples of tools that perform this type of analysis can include Checkmarx SAST, Coverity, Fortify Static Code Analyzer and Klocwork. The output of the SAST operation 204 is a SAST provenance bundle 220. The SAST provenance bundle can include a risk assessment, locations of vulnerabilities, code quality metrics, compliance checks with standards or regulations, remediation suggestions, trend analysis, or a combination thereof.

In certain embodiments, the SBOM 202 of the software build can also be subjected to traditional software composition analysis (SCA) 206. SCA is a process of identifying and analyzing the open-source components in a software build. Examples of tools that perform this type of analysis can include Veracode, Checkmarx SCA, and Snyk. The output of the SCA operation 206 is the SCA provenance bundle 222. The SCA provenance bundle can include a dependency inventory, a license compliance report, an overall code quality report, or a combination thereof.

In certain embodiments, the decision engine workflow 200 can take the SBOM 202 and identify a library used in the software build in operation 208. The operation 208 produces a list of one or more libraries used in the SBOM in 210. The list of libraries can contain one or more open-source libraries. The decision engine workflow 200 can then use the list of libraries 210 to compile various types of metadata of the one or more libraries in the operation to identify metadata 212. These various types of metadata, can include both a security-related attribute of the library, an author-related attribute of the library, or a combination thereof. The incorporation of the metadata enables a more holistic evaluation of a security risk of a library as compared to referencing a CVSS score or other conventional risk assessment metrics.

In certain embodiments, security-related attributes about the open-source libraries used can include, for example, the presence of binary artefacts, whether software screening tools were used in the development of the library, the maintenance status of the library, whether the project requires code reviews before merging code, whether the project cryptographically signs releases, or a combination thereof.

In certain embodiments, author-related attributes of the open-source libraries can include, for example, the number of contributors, the background of the contributors, the number of projects the contributors have authored, whether the contributors are employed or have history of working for historically large projects, the average number of contributions per week of the contributors, or a combination thereof.

Operation 212 can also identify CVEs associated with the one or more libraries in the list of libraries 210. In certain embodiments, more than one CVE identified may be associated with each library. In certain embodiments, the CVE may be limited to a vulnerability that can be exploited within the next 30 days. Operation 212 can retrieve the CVE from a list of CVEs from a variety of different sources, such as, the National Vulnerability Database (NVD) maintained by the U.S. National Institute of Standards and Technology (NIST), the MITRE CVE list maintained by the MITRE corporation, CIRCL CVE search maintained by the Computer Incident Response Center Luxembourg (CIRCL), the exploit DB database maintained by OffSec, or a combination thereof. The operation 212 can also retrieve additional relevant information, such as, a CVSS score, or historical incidences of software vulnerabilities within a specified time period. The output of the identify metadata operation 212 is library data 214 that can then be compiled in operation 216 to output a library provenance bundle 218.

The decision engine workflow 200 can consolidate various provenance bundles into an overall provenance bundle in operation 219. These individual bundles can include the SAST provenance bundle 220, the SCA provenance bundle 222, the library provenance bundle 218, or a combination thereof. This overall provenance bundle 224 can serve as input into the decision engine 226. The decision engine 226 can also include administration policy 228 as inputs.

The administration policy 228 can allow for user or stakeholder input in optimizing risk profiles relating to the software build's releasability. The administration policy 228 can accommodate one or more of varying risk thresholds, allowing for a flexible approach to security assessment. The administration policy 228 can incorporate a customizable user-defined input. The administration policy 228 allows users or stakeholders to configure specific criteria for evaluating the releasability of a software build. The administration policy 228 can be tailored to align with various security requirements and risk tolerance levels unique to the organization or project.

Risk parameters of the administration policy 228 can include, for example, a user-specified risk profile, a user specified risk level, the maximum number of vulnerabilities allowed, a critical vulnerability not permitted, or a combination thereof. The releasability of the software build can be influenced by one or more of the risk parameters of the administration policy 228. In certain embodiments, the releasability of the software build can comprise a weighted factor of one or more risk parameters of the administration policy 228. For example, in certain embodiments, the number of critical vulnerabilities present can have a higher weightage factor in the administration policy 228 when compared to the number of open-source libraries with low CVSS scores. Embodiments can employ a variety of different weighting systems, such as, linear weighting, exponential weighting, dynamic weighting, analytical hierarchy process weighting, stakeholder driven weighting, or a combination thereof.

Both the overall provenance bundle 224 and administration policy 228 are then used as inputs into the decision engine 226 which can use a statistical model to generate a decision report 230. The decision report 230 can include a releasability score which can be an indicative of the probability that the software build is vulnerable to exploitation. The decision report 230 can also include associated data extracted from the overall provenance bundle 224 used in determining the releasability score. In certain embodiments, the associated data output of the decision report 230 can include, for example, a list of vulnerabilities, associated CVEs of the vulnerable open-source libraries, critical CVEs, CVSS scores of all the open-source libraries, software dependency security risks, overall cyber risk profile, risk level of individual library components, probability that the software build can be exploited within the next 30 days, or a combination thereof. In certain embodiments, the decision report 230 can include metrics used in the decision-making process executed by the decision engine 226.

FIG. 3, illustrates, by way of example, a diagram of a gradient boosted decision tree. In certain embodiments, a statistical model used in the decision engine 226 is a gradient boosted decision tree model 300. The gradient boosted decision tree model 300 is a machine learning technique that leverages ensemble learning to create accurate predictive models. The gradient boosted decision tree model operates on the principle of ensemble learning, wherein multiple weak prediction models, typically decision trees 302, are combined to form an accurate predictive model. This approach begins with an initial simple prediction, typically a constant value that minimizes the loss function for the given training data. From this starting point, the model embarks on an iterative process of improvement. In some examples, the loss function used can include a mean squared error (MSE) loss function.

In iterations, the model calculates pseudo-residuals, which represent the errors that need to be corrected. These pseudo-residuals are computed as the gradient of the loss function with respect to the current model's predictions. The model then fits a shallow decision tree, known as a weak learner tree 302, 304, 306, to predict these pseudo-residuals. This tree aims to capture the patterns in the errors of the current ensemble.

After the tree 300 is trained, the model computes prediction values for each leaf node 303 by minimizing the loss function for the training instances that fall into that leaf 303. The predictions of this new tree 304 are then added to the existing ensemble 308, typically scaled by a learning rate to control the contribution of each tree 302, 304, 306. This process can be represented mathematically as:

$${F}_{m} ( x ) = {F}_{m - 1} ( x ) + v {h}_{m} ( x )$$

Where Fₘ(x) is the model after m iterations, hₘ(x) is the prediction of the m-th tree, and ν is the learning rate that is a small positive value. In certain embodiments, ν can be a value between 0 and 1. In certain embodiments, ν can be a value between 0 and 1.

This iterative process can continue for a predetermined number of iterations or until a stopping criterion is met. The result is an ensemble of trees 308, each correcting the errors of its predecessors.

After training the ensemble 308, the model can calculate the importance of each feature based on how often it is used for splitting in the trees and how much it improves the model's performance.

When making predictions for new inputs, the model traverses each tree in the ensemble and sums their individual predictions to obtain the final prediction:

$${F}_{final} ( x ) = {F}_{0} ( x ) + v {\sum }_{1}^{M} {h}_{i} ( x )$$

Where F₀(x) is the initial prediction, M is the total number of trees, and hᵢ(x) is the prediction of the i-th tree.

In certain embodiments, the output of the gradient boosted decision tree 300 can be a releasability score. In certain embodiments, the output of the decision engine 226 can include the releasability score and optionally can include the overall provenance bundle 224, administration policy 228, SBOM 202, a portion thereof, or a combination thereof.

In some examples, the output of the decision engine 226 can be input into a LLM. A LLM is a type of artificial intelligence system designed to understand, generate and manipulate language. LLMs are built using deep learning techniques, such as neural networks, and trained on large amounts of text data. LLMs are trained to learn patterns in language, such as, grammar, semantics and context. LLMs are built to perform various tasks, for example, answering questions, generating texts, or summarizing information. Characteristics of LLMs can include a large number of parameters, trained on a large and diverse source of texts, and the ability to handle a wide range of language-related tasks. Examples of LLMs can include generative pre-trained transformer (GPT) developed by OpenAI, bidirectional encoder representations from transformers (BERT) developed by Google, language model for dialogue applications (LaMDA) developed by google, Bing chat developed by Microsoft, and large language model Meta AI (LLaMA) developed by Meta.

The LLM can take the outputs of the decision engine 226 and provide a user-friendly interpretation of the outputs for user consumption. This enables the user to understand the output of the decision engine 226 and act accordingly. Such action can be mitigating the vulnerability of the software build, releasing of the software build if no vulnerability is detected, releasing of the software build with an acceptable vulnerability present, or a combination thereof. Examples of inputs the LLM receives from the decision engine 226 can include the releasability score, the number of CVEs with critical CVSS scores, the number of CVEs with high CVSS scores, the number of CVEs with medium CVSS scores, the number of CVEs with low CVSS scores, the critical CVEs identified, or a combination thereof. The LLM can also take in inputs of the overall provenance bundle 224 and the administration policy 228 as supporting information. The output of the LLM can include a report.

For the one or more components of the output of the LLM, a tailored prompt can be created. The one or more prompts can be manually composed by a user, automatically generated, derived from predefined templates, generated based on historical data patterns, extracted from relevant documents and specifications, created through iterative refinement using feedback loops from previous LLM inputs, or a combination thereof.

In some examples, a tailored prompt can include a system prompt to collect information from the decision engine 226, such as, a risk score calculated by the gradient boosted decision tree model 300, and generate a report. This tailored prompt can instruct the LLM to summarize all the information in a page or less, incorporating relevant context to explain the factors behind the decision made.

FIGS. 4A and 4B illustrate, by way of example, respective diagrams of embodiments of DESIR releasability reports. In certain embodiments, the DESIR releasability report 400 can include information, such as, a recommendation for releasability 402, a releasability score 404, a list of vulnerabilities identified in the form of CVEs, a list of vulnerable dependencies 406, highlights of a critical dependency, identification of the weakest dependency, a written description of the identified security vulnerability 408, generated graphs 410, CVSS scores of each library, the total number of CVEs and their classifications, or a combination thereof. Embodiments allow for the report to include the probability a single CVE is exploited in the next 30 days, the probability at least one CVE is exploited in the next 30 days, the probability any CVE is exploited in the next 30 days on any dependency, or a combination thereof. In some examples, the generated graphs 410 can include information on the weights of the features used in making the decision to release the software build, or a diagram of the gradient boosted tree used in arriving at the releasability score.

Embodiments can present this information in textual representations, graphical representations, or a combination thereof to enhance data presentation. In certain embodiments, a graphical element can be incorporated into the report by integrating an output from an automated graphical or image generation program or software. These programs can include data visualization tools used for creating interactive charts and graphs, diagramming software for generating flowcharts or network diagrams, advanced generative AI systems for producing custom illustrations or infographics, or a combination thereof.

In some examples, elements, such as, charts and tables can be incorporated into the DESIR releasability report 400 algorithmically through tools, such as, matplotlib, pandas, numpy, or a combination thereof.

The report generation operation 120 of FIG. 1 can also output a list of vulnerabilities 124 that is then used to identify a remedy at operation 126.

FIG. 5 illustrates, by way of example, a flow diagram of an embodiment of an iterative process for assessing a vulnerability in a software build. In certain embodiments, the system 100 can be used as an iterative process 500 until the software build is recommended for release 510. The iterative process 500 can be executed multiple times during the development of the software build, or after its launch. In certain embodiments, this iterative process 500 can be managed in a variety of different ways, such as, scheduled periodically, aligned according to product development milestones, on-demand when specified, whenever the SBOM is updated, or a combination thereof. Embodiments allow for the software build 501 to be processed into a SBOM format 502 in the generate SBOM operation 505.

The SBOM 502 of the software build 501 can be input into the decision engine 503. In certain embodiments, the decision engine 503 can take in inputs of an overall provenance bundle 224, an administration policy 228, or a combination thereof to determine if the software build 501 has a security vulnerability 504. If there is no significant security vulnerability, the operation 504 recommends the release of the software build in a subsequent operation 510. In certain embodiments, the software build can still be recommended for release 510 even in there is a vulnerability 504, depending on the administration policy 228 incorporated into the decision engine 503. If the decision engine 503 determines that the software build has a significant security vulnerability 504, the iterative process 500 can move to the next operation of identifying a remedy 506 for the security vulnerability 504. In certain embodiments, identification of a remedy 506 can include, for example, recommending a patch, identifying a more recent updated patch, locating the more recent updated patch, recommending removal or replacement of the vulnerable library, or a combination thereof. Once the remedy has been identified in operation 506, the iterative process 500 can execute the remedy in operation 508. Embodiments can include automatic or manual patching, updating, or replacement of the vulnerable library.

Upon execution of the remedy 508, the iterative process 500 can reroute the patched software build back to the start of the iterative process 500 by generating an updated SBOM 502 in the generate SBOM operation 505. With the updated SBOM 502, the iterative process 500 then proceeds to the decision engine operation 503 again to ensure that the software build no longer contains an unacceptable software vulnerability. This iterative method can be executed at fixed time periods or at project milestones. This iterative process 500 can be employed throughout the software build development process. In certain embodiments, this iterative process 500 can be used as a final approval step at the end of the development process for release and launch of the software build. This iterative process 500 can also be used for a launched or released software build. In certain embodiments, the released or launched software build can periodically be checked for a vulnerability at pre-determined periods, on-demand when specified, whenever the SBOM is updated, or a combination thereof.

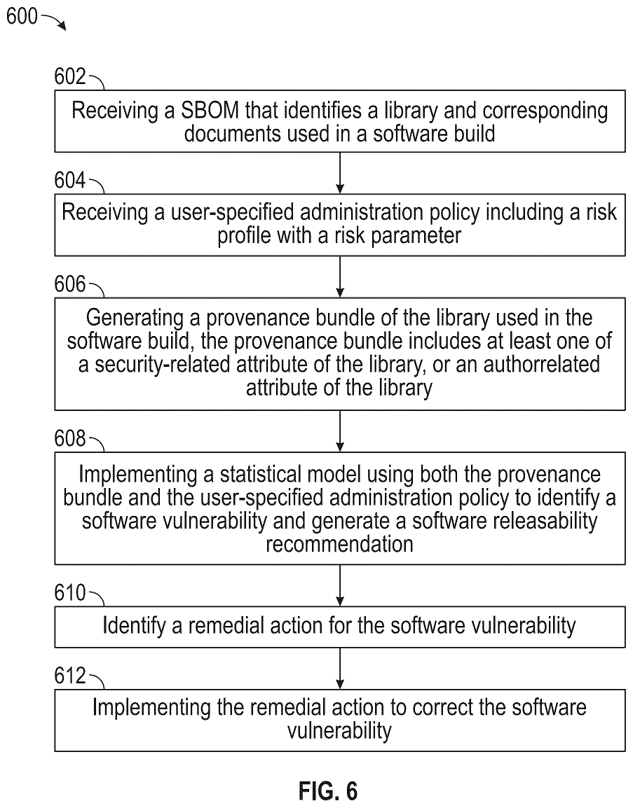

FIG. 6, illustrates, by way of example, a diagram of an embodiment of a method for assessing a software vulnerability in a software build and mitigating the software vulnerability through a remedial action. The method 600, as illustrated includes receiving a SBOM that identifies a library and corresponding documents used in a software build, at operation 602; receiving a user-specified administration policy including a risk profile with a risk parameter, at operation 604; generating a provenance bundle of the library used in the software build, the provenance bundle includes a security-related attribute of the library and an author-related attribute of the library, at operation 606; implementing a statistical model using both the provenance bundle and the user-specified administration policy to identify a software vulnerability; generate a software releasability recommendation, at operation 608; identify a remedial action for the software vulnerability, at operation 610; and implementing the remedial action to correct the software vulnerability, at operation 612.

The method 600 can further include generating a prompt, providing the prompt to a LLM, receiving the software releasability recommendation into the LLM, and generating a recommendation report responsive to the prompt and the software releasability recommendation.

The operation 604 can further include, wherein the risk parameter includes one or more of a maximum number of vulnerabilities allowed, or a critical vulnerability not allowed.

The operation 606 can further include, wherein generating of the provenance bundle includes compiling one or more of a SAST provenance bundle, a SCA provenance bundle, or a library provenance bundle.

The operation 606, can further include, wherein the security-related attribute includes one or more of a presence of binary artefacts, a use of software screening tools, a maintenance status of the library, or a presence of a contributor sign-off.

The operation 606, can further include, wherein the author-related attribute includes one or more of a number of contributors, an age of a contributor, a background of a contributor, a number of projects authored by a contributor, or an employment history of a contributor.

The operation 608, can further include, wherein the statistical model is a gradient boosted decision tree algorithm.

The operation 608, can further include, wherein the software releasability recommendation includes one or more of a releasability score, a build provenance, a software dependency security risk, a risk level of individual library components, or a probability that the software build can be exploited within next 30 days.

The operation 612, can further include, wherein implementing of the remedial action is implemented automatically without a user input.

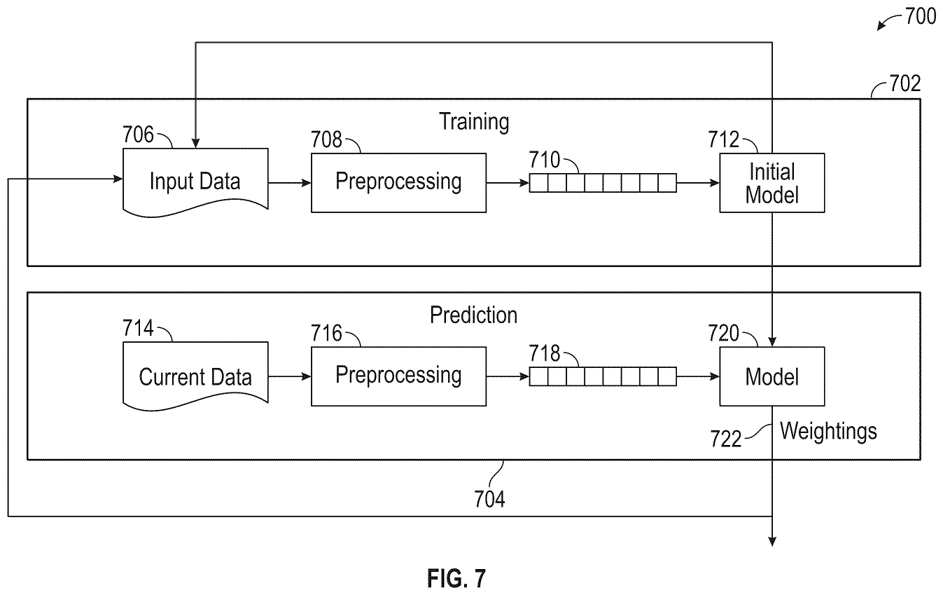

FIG. 7, illustrates, by way of example, a machine learning engine for training a ML model. According to various examples, the machine learning engine may be deployed to execute at a mobile device (e.g., a cell phone, a tablet, etc.) or a computer (e.g., a desktop, a laptop, etc.). FIG. 7 shows an example machine learning engine 700 according to some examples of the present disclosure.

Machine learning engine 700 uses a training engine 702 and a prediction engine 704. Training engine 702 uses input data 706, for example after undergoing preprocessing component 708, to determine one or more features 710. The one or more features 710 may be used to generate an initial model 712, which may be updated iteratively or with future labeled or unlabeled data (e.g., during reinforcement learning), for example to improve the performance of the prediction engine 704 or the initial model 712. An improved model may be redeployed for use.

The input data 706 may include software builds or hypothetical software builds that were determined to be either releasable or unreleasable corresponding to one or more of the administration policies 110. As part of the projects used for training, embodiments can use inputs of both an overall provenance bundle 224 and an administration policy 228.

In the prediction engine 704, current data 714 (e.g., SBOMs 202) may be input to preprocessing component 716. In some examples, preprocessing component 716 and preprocessing component 708 are the same. The prediction engine 704 produces feature vector 718 from the preprocessed current data, which is input into the model 720 to generate one or more criteria weightings 722. The criteria weightings 722 may be used to output a prediction, as discussed further below.

The training engine 702 may operate in an offline manner to train the model 720 (e.g., on a server). The prediction engine 704 may be designed to operate in an online manner (e.g., in real-time, at a mobile device, on a wearable device, etc.). In some examples, the model 720 may be periodically updated via additional training (e.g., via updated input data 706 or based on labeled or unlabeled data output in the weightings 722) or based on identified future data, such as by using reinforcement learning to personalize a general model (e.g., the initial model 712) to a particular user.

The initial model 712 may be updated using further input data 706 until a satisfactory model 720 is generated. The model 720 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine may be selected from among many different potential supervised or unsupervised machine learning algorithms. Examples of ML models include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 702. In an example embodiment, a regression model is used and the model 720 is a vector of coefficients corresponding to a learned importance for each of the features in the vector of features 710, 718. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

After training, the model 720 is configured to output a prediction, such as, a releasability score based on the inputs of both an overall provenance bundle and administration policy.

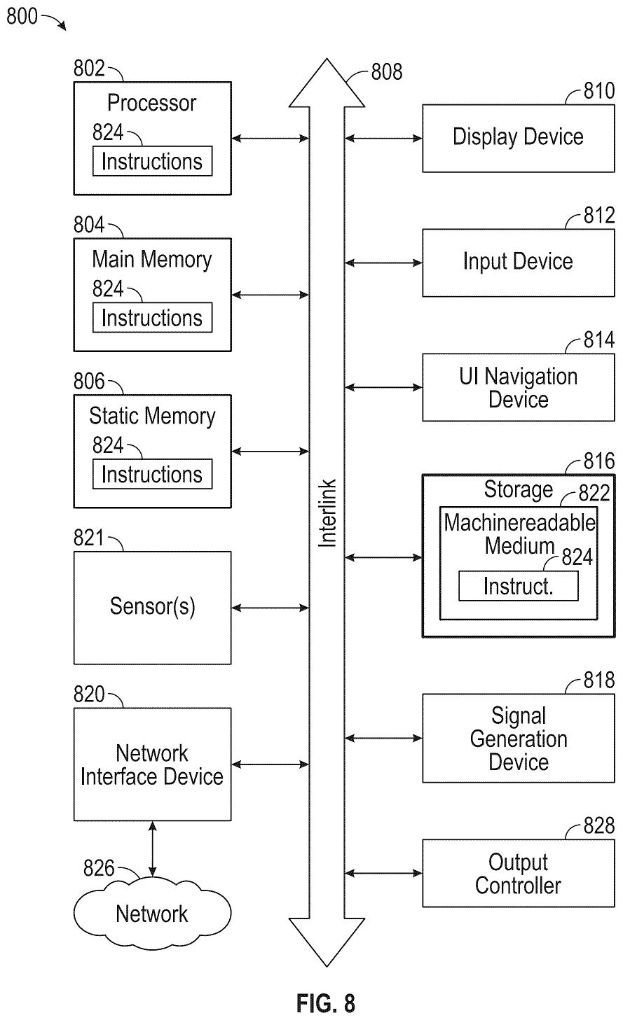

FIG. 8 illustrates, by way of example, a block diagram of an embodiment of a machine in the example form of a computer system within which instructions, for causing the machine to perform any one or more of the methodologies discussed herein, may be executed.

A variety of operations, methodologies, or processes described herein may be executed, implemented or performed by one or more of the components of the computer system 800, for example, the system 100, data compilation operation 104, SBOM input into a decision engine 200, provenance bundle compilation 219, decision engine 226, gradient decision tree model 300, LLM, iterative process 500, method 600, or machine learning engine 700. In a networked deployment, the machine may operate in the capacity of a server or a client machine in server-client network environment, or as a peer machine in a peer-to-peer (or distributed) network environment. The machine may be a personal computer (PC), server, a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation device 814 (e.g., a mouse), a mass storage unit 816, a signal generation device 818 (e.g., a speaker), a network interface device 820, and a radio 830 such as Bluetooth, WWAN, WLAN, and NFC, permitting the application of security controls on such protocols.

The mass storage unit 816 includes a machine-readable medium 822 on which is stored one or more sets of instructions and data structures (e.g., software) 824 embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media.

While the machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present invention, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 824 may further be transmitted or received over a communications network 826 using a transmission medium. The instructions 824 may be transmitted using the network interface device 820 and any one of a number of well-known transfer protocols (e.g., HTTPS). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### Examples and Additional Notes

Each of the following non-limiting examples can stand on its own or can be combined in various permutations or combinations with one or more of the other examples.

Example 1 includes a method for mitigating a software vulnerability, the method comprising receiving a software bill of materials (SBOM) that identifies a library and corresponding documents used in a software build, receiving a user-specified administration policy including a risk profile with a risk parameter, generating a provenance bundle of the library used in the software build, the provenance bundle includes at least one of a security-related attribute of the library, or an author-related attribute of the library; implementing a statistical model using both the provenance bundle and the user-specified administration policy to identify a software vulnerability and generate a software releasability recommendation, identifying a remedial action for the software vulnerability, and implementing the remedial action to correct the software vulnerability.

Example 2, the subject matter of Example 1 includes, generating a prompt, receiving the software releasability recommendation into the prompt resulting in an augmented prompt, providing the augmented prompt to a large language model (LLM), and generating a recommendation report responsive to the augmented prompt.

Example 3, the subject matter of Example 1-2, includes wherein the risk parameter includes one or more of a maximum number of vulnerabilities allowed, or a critical vulnerability not allowed.

Example 4, the subject matter of Example 1-3, includes wherein generating of the provenance bundle includes compiling one or more of a static application security testing (SAST) providence bundle, a software composition analysis (SCA) provenance bundle, or a library provenance bundle.

Example 5, the subject matter of Example 1-4, includes wherein the security-related attribute of the library includes one or more of a presence of binary artefacts, a use of software screening tools, a maintenance status of the library, or a presence of a contributor sign-off.

Example 6, the subject matter of Example 1-5, includes wherein the author-related attribute of the library includes one or more of a number of contributors, an age of a contributor, a background of a contributor, a number of projects authored by a contributor, or an employment history of a contributor.

Example 7, the subject matter of Example 1-6, includes wherein the statistical model is a gradient boosted decision tree algorithm.

Example 8, the subject matter of Example 1-7, includes wherein the software releasability recommendation includes one or more of a releasability score, a build provenance, a software dependency security risk, a risk level of individual library components, or a probability that the software build can be exploited within next 30 days.

Example 9, the subject matter of Example 1-8, includes wherein implementing of the remedial action is implemented automatically.

Example 10 includes, a system comprising, a computer processor, and a computer memory coupled to the computer processor, wherein the computer processor and the computer memory are operable for: receiving a software bill of materials (SBOM) that identifies a library and corresponding documents used in a software build; receiving a user-specified administration policy including a risk profile with a risk parameter, generating a provenance bundle of the library used in the software build, the provenance bundle includes at least one of a security-related attribute of the library, or an author-related attribute of the library, implementing a statistical model using both the provenance bundle and the user-specified administration policy to identify a software vulnerability and generate a software releasability recommendation, identifying a remedial action for the software vulnerability, and implementing the remedial action to correct the software vulnerability.

Example 11, the subject matter of Example 10 includes, generating a prompt, receiving the software releasability recommendation into the prompt resulting in an augmented prompt, providing the augmented prompt to a large language model (LLM), and generating a recommendation report responsive to the augmented prompt.

Example 12, the subject matter of Example 10-11, includes wherein generating of the provenance bundle includes compiling one or more of a static application security testing (SAST) providence bundle, a software composition analysis (SCA) provenance bundle, or a library provenance bundle.

Example 13, the subject matter of Example 10-12, includes wherein the statistical model is a gradient boosted decision tree algorithm.

Example 14, the subject matter of Example 10-13, includes wherein the software releasability recommendation includes one or more of a releasability score, a build provenance, a software dependency security risk, a risk level of individual library components, or a probability that the software build can be exploited within next 30 days.

Example 15, the subject matter of Example 10-14, includes wherein implementing of the remedial action is implemented automatically.

Example 16, includes a non-transitory machine-readable medium including instructions that, when executed by a machine, cause the machine to perform operations for mitigating a software vulnerability, the operations comprising receiving a software bill of materials (SBOM) that identifies a library and corresponding documents used in a software build, receiving a user-specified administration policy including a risk profile with a risk parameter, generating a provenance bundle of the library used in the software build, the provenance bundle includes at least one of a security-related attribute of the library, or an author-related attribute of the library, implementing a statistical model using both the provenance bundle and the user-specified administration policy to identify a software vulnerability and generate a software releasability recommendation, identifying a remedial action for the software vulnerability, and implementing the remedial action to correct the software vulnerability.

Example 17, the subject matter of Example 16, includes generating a prompt, receiving the software releasability recommendation into the prompt resulting in an augmented prompt; providing the augmented prompt to a large language model (LLM), and generating a recommendation report responsive to the augmented prompt.

Example 18, the subject matter of Example 16-17, includes wherein generating of the provenance bundle includes compiling one or more of a static application security testing (SAST) providence bundle, a software composition analysis (SCA) provenance bundle, or a library provenance bundle.

Example 19, the subject matter of Example 16-18, includes wherein the statistical model is a gradient boosted decision tree algorithm.

Example 20, the subject matter of Example 16-19, includes wherein the software releasability recommendation includes one or more of a releasability score, a build provenance, a software dependency security risk, a risk level of individual library components, or a probability that the software build can be exploited within next 30 days.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instance or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for mitigating a software vulnerability, the method comprising:
receiving a software bill of materials (SBOM) that identifies a library and corresponding documents used in a software build;
receiving a user-specified administration policy including a risk profile with a risk parameter;
generating a provenance bundle of the library used in the software build, the provenance bundle includes at least one of a security-related attribute of the library, or an author-related attribute of the library;
implementing a statistical model using both the provenance bundle and the user-specified administration policy to identify a software vulnerability and generate a software releasability recommendation; and
implementing the software releasability recommendation by releasing the software build or blocking the release of the software build based on the software releasability recommendation.

2. The method of claim 1, further comprising:
identifying a remedial action for the software vulnerability; and
implementing the remedial action to correct the software vulnerability.

3. The method of claim 1, further comprising:
generating a prompt;
receiving the software releasability recommendation into the prompt resulting in an augmented prompt;
providing the augmented prompt to a large language model (LLM); and
generating a recommendation report responsive to the augmented prompt.

4. The method of claim 1, wherein the risk parameter includes one or more of a maximum number of vulnerabilities allowed, or a critical vulnerability not allowed.

5. The method of claim 1, wherein generating of the provenance bundle includes compiling one or more of a static application security testing (SAST) providence bundle, a software composition analysis (SCA) provenance bundle, or a library provenance bundle.

6. The method of claim 1, wherein the security-related attribute of the library includes one or more of a presence of binary artefacts, a use of software screening tools, a maintenance status of the library, or a presence of a contributor sign-off.

7. The method of claim 1, wherein the author-related attribute of the library includes one or more of a number of contributors, an age of a contributor, a background of a contributor, a number of projects authored by a contributor, or an employment history of a contributor.

8. The method of claim 1, wherein the statistical model is a gradient boosted decision tree algorithm.

9. The method of claim 1, wherein the software releasability recommendation includes one or more of a releasability score, a build provenance, a software dependency security risk, a risk level of individual library components, or a probability that the software build can be exploited within next 30 days.

10. The method of claim 1, wherein implementing of the remedial action is implemented automatically.

11. A system comprising:
a computer processor; and
a computer memory coupled to the computer processor;
wherein the computer processor and the computer memory are operable for:
receiving a software bill of materials (SBOM) that identifies a library and corresponding documents used in a software build;
receiving a user-specified administration policy including a risk profile with a risk parameter;
generating a provenance bundle of the library used in the software build, the provenance bundle includes at least one of a security-related attribute of the library, or an author-related attribute of the library;
implementing a statistical model using both the provenance bundle and the user-specified administration policy to identify a software vulnerability and generate a software releasability recommendation; and
implementing the software releasability recommendation by releasing the software build or blocking the release of the software build based on the software releasability recommendation.

12. The system of claim 11, wherein the computer processor and the computer memory are further operable for:
identifying a remedial action for the software vulnerability; and
implementing the remedial action to correct the software vulnerability.

13. The system of claim 11, wherein the computer processor and the computer memory are further operable for:
generating a prompt;
receiving the software releasability recommendation into the prompt resulting in an augmented prompt;
providing the augmented prompt to a large language model (LLM); and
generating a recommendation report responsive to the augmented prompt.

14. The system of claim 11, wherein generating of the provenance bundle includes compiling one or more of a static application security testing (SAST) providence bundle, a software composition analysis (SCA) provenance bundle, or a library provenance bundle.

15. The system of claim 11, wherein the statistical model is a gradient boosted decision tree algorithm.

16. The system of claim 11, wherein the software releasability recommendation includes one or more of a releasability score, a build provenance, a software dependency security risk, a risk level of individual library components, or a probability that the software build can be exploited within next 30 days.

17. The system of claim 11, wherein implementing of the remedial action is implemented automatically.

18. A non-transitory machine-readable medium including instructions that, when executed by a machine, cause the machine to perform operations for mitigating a software vulnerability, the operations comprising:
receiving a software bill of materials (SBOM) that identifies a library and corresponding documents used in a software build;
receiving a user-specified administration policy including a risk profile with a risk parameter;
generating a provenance bundle of the library used in the software build, the provenance bundle includes at least one of a security-related attribute of the library, or an author-related attribute of the library;
implementing a statistical model using both the provenance bundle and the user-specified administration policy to identify a software vulnerability and generate a software releasability recommendation; and
implementing the software releasability recommendation by releasing the software build or blocking the release of the software build based on the software releasability recommendation.

19. The non-transitory machine-readable medium of claim 18, wherein the operations further comprise:
identifying a remedial action for the software vulnerability; and
implementing the remedial action to correct the software vulnerability.

20. The non-transitory machine-readable medium of claim 18, wherein the operations further comprise:
generating a prompt;
receiving the software releasability recommendation into the prompt resulting in an augmented prompt;
providing the augmented prompt to a large language model (LLM); and
generating a recommendation report responsive to the augmented prompt.

21. The non-transitory machine-readable medium of claim 18, wherein generating of the provenance bundle includes compiling one or more of a static application security testing (SAST) providence bundle, a software composition analysis (SCA) provenance bundle, or a library provenance bundle.

22. The non-transitory machine-readable medium of claim 18, wherein the statistical model is a gradient boosted decision tree algorithm.

23. The non-transitory machine-readable medium of claim 18, wherein the software releasability recommendation includes one or more of a releasability score, a build provenance, a software dependency security risk, a risk level of individual library components, or a probability that the software build can be exploited within next 30 days.
